(19) United States
(12) Patent Application Publication
(10) Pub. No.: US 2025/0323578 A1
(43) Pub. Date: Oct. 16, 2025

(54) PER-PHASE CONTROL FOR POWER CONVERTERS

(71) Applicant: TEXAS INSTRUMENTS INCORPORATED, DALLAS, TX (US)

(72) Inventors: Vikram GAKHAR, BANGALORE (IN); Preetam TADEPARTHY, BANGALORE (IN); Rohit NARULA, BANGALORE (IN); Vikas LAKHANPAL, BANGALORE (IN)

(21) Appl. No.: 18/673,646

(22) Filed: May 24, 2024

Related U.S. Application Data
(60) Provisional application No. 63/632,678, filed on Apr. 11, 2024.

(51) Int. Cl. H02M 3/158; H02M 1/00

(52) U.S. Cl. CPC H02M 3/1586; H02M 1/0009

(57) ABSTRACT

An example circuit includes a multiphase loop controller having phase current inputs, a feedback input, and a control loop output. A first phase loop controller includes a first phase current input, a first feedback input, and a first phase loop output, in which the first feedback input is coupled to the feedback input. A second phase loop controller includes a second phase current input, a second feedback input, and a second phase loop output. Pulse generator circuitry includes first, second, and third pulse control inputs, and first and second pulse outputs, in which the first pulse control input is coupled to the control loop output, the second pulse control input is coupled to the first phase loop output, and the third pulse control input is coupled to the second phase loop output.

### CROSS-REFERENCE TO RELATED APPLICATION

This application claims priority to U.S. provisional patent application No. 63/632,678, filed Apr. 11, 2024, which Application is hereby incorporated herein by reference in its entirety.

### TECHNICAL FIELD

This description relates to per-phase control for multiphase power converters.

### BACKGROUND

There are a variety of different power converter topologies. For example, multiphase buck converters are evolving and are being used to support high current demand with steep load transients. The load transient is largely dependent on the output capacitor bank which is adapted to prevent faster current rise. A trans-inductor voltage regulator (TLVR) topology can be used in conjunction with multiphase power converters to help reduce load transients. Multiphase converters using the TLVR as well as other topologies can exhibit reduced performance due to asymmetry between respective phases.

### SUMMARY

One described example relates to a circuit including a multiphase loop controller, a first phase loop controller, a second phase loop controller, and pulse generator circuitry. The multiphase loop controller includes phase current inputs, a feedback input, and a control loop output. The first phase loop controller includes a first phase current input, a first feedback input, and a first phase loop output, in which the first feedback input is coupled to the feedback input of the multiphase loop controller. The second phase loop controller includes a second phase current input, a second feedback input, and a second phase loop output. The pulse generator circuitry includes first, second, and third pulse control inputs, and first and second pulse outputs, in which the first pulse control input is coupled to the control loop output, the second pulse control input is coupled to the first phase loop output of the first phase loop controller, and the third pulse control input is coupled to the second phase loop output of the second phase loop controller.

Another described example relates to a circuit that includes a multiphase loop controller configured to provide a system error signal based on a feedback signal and a combined measure of current. The feedback signal is representative of a power converter output voltage, and the combined measure of current is representative of current provided to a plurality of power converter phases. A per-phase loop controller is configured to provide a phase error signal for a respective phase of the plurality of power converter phases based on the feedback signal and a measure of current of the respective phase. Pulse generator circuitry is configured to provide a pulsed signal for the respective phase responsive to the phase error signal and the system error signal.

Another described example relates to a power converter circuit that includes a control circuit, first power stage, and a second power stage. The control circuit includes a multiphase loop controller, a first phase loop controller, a second phase loop controller, and a pulse generator. The multiphase loop controller includes first and second phase current inputs, a first feedback input, and a control loop output, in which the first feedback input is coupled to an output terminal of the power converter circuit. The first phase loop controller includes a first phase current input, a second feedback input, and a first phase loop output, in which the second feedback input is coupled to the first feedback input. The second phase loop controller includes a second phase current input, a third feedback input, and a second phase loop output. The pulse generator circuit includes first, second, and third pulse control inputs and first and second pulse outputs. The first pulse control input is coupled to the control loop output, the second pulse control input is coupled to the first phase loop output, and the third pulse control input is coupled to the second phase loop output. The first power stage includes a first control input and a first switching output, in which the first control input is coupled to the first pulse output, the first switching output is coupled to the output terminal. The second power stage includes a second control input and a second switching output, in which the second control input is coupled to the second pulse output and the second switching output is coupled to the output terminal.

### BRIEF DESCRIPTION OF THE DRAWINGS

FIG. 1 is a schematic diagram illustrating an example multiphase power converter circuit.

FIG. 2 is a block diagram illustrating an example controller for a multiphase power converter.

FIG. 3 is a block diagram illustrating another example controller for a multiphase power converter.

FIG. 4 is a schematic diagram illustrating an example analog control circuit for a multiphase power converter.

FIG. 5 is a block diagram of an example multiphase power converter having a first arrangement of power stages.

FIG. 6 is a block diagram of an example multiphase power converter having a second arrangement of power stages.

FIGS. 7A and 7B are plots showing electrical parameters for different power converters.

FIG. 8 is a block diagram illustrating a power system for a computing apparatus implementing an example multiphase power converter.

### DETAILED DESCRIPTION

This description relates generally to circuits and systems, such as for controlling multiphase power converters.

As an example, a circuit includes a multiphase loop controller configured to provide a system error signal based on a feedback signal and a combined measure of current. The feedback signal is representative of an output voltage of a power converter, and the combined measure of current is representative of current provided to a plurality of phases of the power converter. The circuit also includes one or more per-phase loop controllers, each configured to provide a phase error signal for a respective phase of the plurality of phases based on the feedback signal and a measure of current of the respective phase. The circuit is configured to provide a phase control signal to control the respective phase based on the system error signal and the phase error signal. The circuit can also include a pulse width modulation (PWM) generator that is configured to provide a PWM signal for the respective phase responsive to the phase control signal. Each phase of the multiphase power converter can include a respective power stage that is configured to provide a phase voltage responsive to a PWM signal provided for the respective phase. The circuit described herein can implement per-phase control to reduce systematic asymmetries in power stages of the multiphase power converter. As an example, each of the per-phase loop controllers can configure scaling and gain parameters, which can vary for each phase, to balance the loop responses of the respective phases.

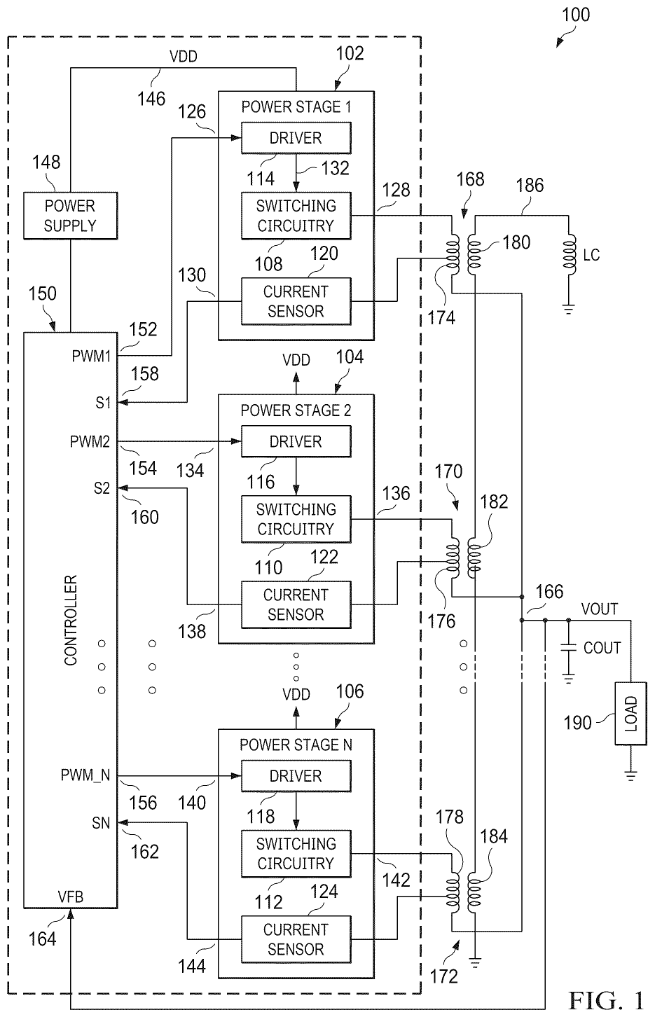

FIG. 1 is a schematic diagram illustrating an example multiphase power converter circuit 100 (also referred to as a multiphase voltage regulator). The multiphase power converter circuit 100 includes a plurality of power stages 102, 104, and 106, shown as power stages 1 through N, where N is a positive integer greater than or equal to two representing the number of power stages and/or number of phases. In an example, each of the N power stages 102, 104, and 106 is implemented as an instance of a respective integrated circuit (IC) configured to provide a respective phase voltage of the multiphase power converter circuit 100. Each of the power stages 102, 104, and 106 thus can include switching circuitry 108, 110, 112, driver circuitry 114, 116, and 118, and a current sensor 120, 122, and 124. Each power stage 102, 104, and 106 can also include other circuitry (not shown) configured to perform other functions, such as including circuitry to sense one or more operating conditions (e.g., temperature, voltage or the like).

In the example of FIG. 1, the power stage 102 has a control input 126, a switching output 128, and a current sense output 130. The driver 114 has an input coupled to the control input 126 and an output coupled to a control input 132 of the switching circuitry 108. The current sensor 120 includes circuitry within the power stage 102 that is configured to measure the current for the respective phase (also referred to as phase current). The current sensor 120 has an output coupled to the current sense output 130 and is configured to provide a current sense signal representative of the measured phase current at the current sense output. In the example of FIG. 1, the current sensor 120 has an input shown schematically coupled to the phase winding. In practice, however, the current sensing function for each power stage 102, 104, 106 can be implemented internally within the respective power stage without separate connections coupled to the winding or the output. In other examples, current sensing circuitry can be coupled to winding, sense resistors or other circuitry within the current path of the respective power stage.

Each of the other N−1 power stages 104 and 106 can be implemented in the manner described with respect to the power stage 102. Thus, the power stage 104 has a control input 134, a switching output 136, and a current sense output 138. Similarly, the power stage 106 has a control input 140, a switching output 142, and a current sense output 144. Each of the current sensors 120, 122, and 124 has a respective sense input coupled to a respective current path to which the respective switching outputs 128, 136, and 142 are coupled for sensing current, such as described herein. In the example of FIG. 1, each of the power stages 102, 104, and 106 also has a respective power input terminal coupled to a supply voltage output 146. For example, a power supply 148 is configured to provide a supply voltage at the supply voltage output 146, such as a regulated DC voltage VDD.

The circuit 100 also includes a controller 150 having N control outputs 152, 154, and 156 and N sense terminals 158, 160, and 162, shown as S1, S2 through SN. Each of the control outputs 152, 154, and 156 is coupled to a respective control input 126, 134, and 140 of the power stages 102, 104, and 106. Each of the sense terminals 158, 160, 162 is coupled to a respective current sense output 130, 138, and 144 of the power stages 102, 104, and 106. The controller 150 also has a feedback input 164 coupled to an output terminal 166 of the multiphase power converter circuit 100. The controller 150 is configured to provide N control signals at 152, 154, and 156 to regulate a power converter output voltage VOUT at the output terminal 166 (where N is a positive integer representative of the number phases that can be controlled by the controller 150). For example, the control signals at 152, 154, and 156 are PWM control signals provided to selectively turn on and turn off the respective power stages 102, 104, and 106 for providing respective phase voltages and currents at their switching outputs 128, 136, and 142, which combine to provide VOUT at the output terminal 166. A feedback voltage VFB is received at the feedback input 164 of the controller representative of the voltage VOUT at the output terminal 166.

In the example of FIG. 1, the multiphase power converter circuit 100 is implemented according to a trans-inductor voltage regulator (TLVR) topology, and a respective transformer 168, 170, and 172 is coupled to the switching output 128, 136, and 142 of each power stage 102, 104, and 106. Other power converter topologies can be used in other examples. As illustrated in FIG. 1, a primary winding 174 of the transformer 168 is coupled between the switching output 128 and the output terminal 166. The primary winding 176 of the transformer 170 is coupled between the switching output 136 and the output terminal 166. And a primary winding 178 of the transformer 172 is coupled between the switching output 142 and the output terminal 166. Each of the transformers 168, 170, and 172 also has a respective secondary winding 180, 182, and 184 coupled in series with a compensation inductor LC to define a compensation path 186, which can be coupled between ground terminals 188. For example, the compensation path is configured to reduce transients at the output terminal 166 by dissipating current, which is induced from the primary to the secondary windings, through the inductor LC in the compensation path 186.

In the example of FIG. 1, a load 190 is coupled to the output terminal 166 in parallel with a capacitor COUT. The load 190 can include a processor, a data storage device, an electric motor, a lighting system, an automotive system, a network infrastructure, audio and video devices, a robot, a computing device, or other types of loads. As described herein, the controller 150 is configured to implement per-phase loop control that reduces phase-to-phase mismatches and improves the transient response of the multiphase power converter circuit 100 compared to existing control designs.

By way of example, the controller 150 includes a multiphase loop controller configured to provide a system error signal for the multiphase power converter circuit 100 based on the feedback signal VFB at 164 and a combined measure of current. The combined measure of current can be representative of current provided to a plurality of phases, such as derived from the current sense signals received at sense terminals 158, 160, and 162 from the respective current sensors 120, 122, and 124. In an example, each of the current sensors 120, 122, and 124 includes a current sense resistor in series with the primary winding (e.g., inductor) of the respective phase. The controller 150 also includes per-phase loop controllers for each phase of the multiphase power converter circuit 100. For example, each per-phase loop controller is configured to provide a respective phase error signal based on the feedback signal and a measure of current of the respective phase, such as provided by the current sensor of the respective power stage 102, 104, or 106. The controller is further configured to combine the system error signal and the phase error signal to provide a phase control signal for each respective phase. The controller 150 can also include PWM circuitry configured to provide PWM signals at respective control outputs 152, 154, and 156 responsive to the phase control signal for driving each phase.

As a further example, the driver circuitry 114, 116, and 118 of each power stage 102, 104, and 106 is configured to provide a drive signal at the control input thereof responsive to the phase control signal (e.g., or other logic signal) provided by the controller 150 at respective control outputs 152,154, and 156. Each of the switching circuitry 108, 110, 112 is configured to provide a phase voltage at the switching output 128, 136, 142 based on the drive signal at the respective control input thereof. For example, the switching circuitry 108, 110, 112 is implemented as a half-bridge that includes transistors (e.g., field effect transistors) configured to provide the phase voltage and current along a path from the respective switching output 128, 136, and 142, through the primary winding 174, 176, 178, and to the output terminal 166.

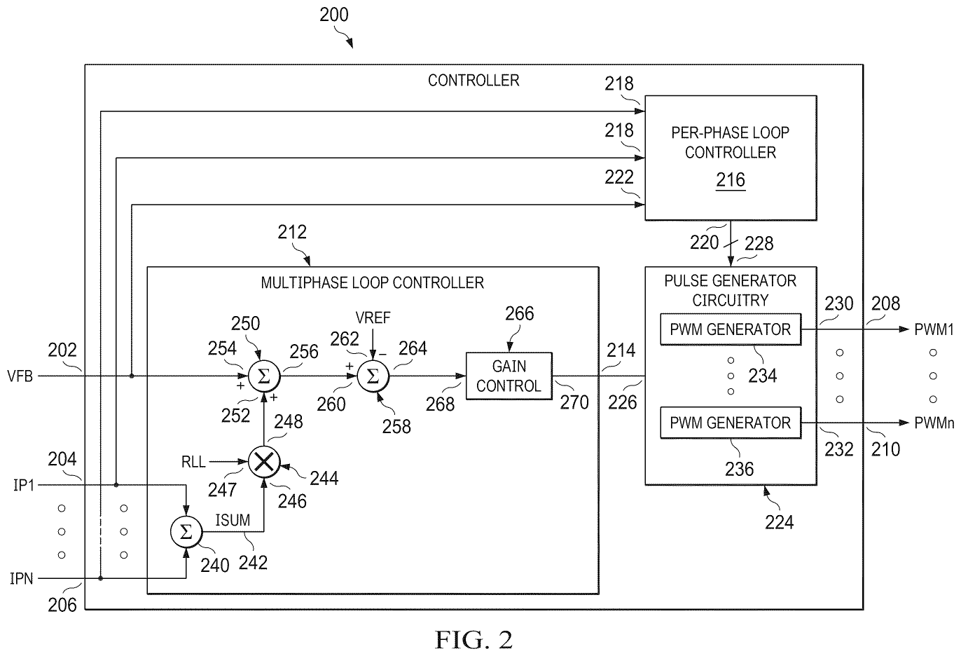

FIG. 2 is a block diagram illustrating an example controller 200. The controller 200 is an example of the controller 150 described with respect to FIG. 1. Accordingly, the description of FIG. 2 also refers to FIG. 1. The controller 200 has a feedback input 202, a plurality of N phase current inputs 204 and 206, and a plurality of N control outputs 208 and 210 (where N is a positive integer representative of the number phases that can be controlled by the controller 200). The controller 200 can be implemented as an IC or by an arrangement of discrete components, which can include digital and/or analog components.

The controller 200 includes a multiphase loop controller 212 having (or coupled to) the phase current inputs, the feedback input 202, and a control loop output 214. The controller 200 also includes per-phase loop controller 216 having a phase current input 218 and a phase loop output 220 for each respective phase. The per-phase loop controller 216 also has a feedback input 222 coupled to the feedback input 202. The per-phase loop controller 216 can include N phase loop controllers, in which a phase loop controller is provided for each respective phase of a multiphase power converter. For example, the per-phase loop controller 216 includes a first phase loop controller having a first phase current input, a first feedback input, and a first phase loop output, in which the first feedback input is coupled to the feedback input. The per-phase loop controller 216 can also include a second phase loop controller having a second phase current input, a second feedback input, and a second phase loop output.

The controller 200 also includes pulse generator circuitry 224 having pulse control inputs 226 and 228 and pulse outputs 230 and 232. The pulse control input 226 is coupled to the control loop output 214 and the other pulse control input 228 is coupled to the phase loop output 220. There can be N+1 pulse control inputs depending on the number of phases. In an example, the pulse generator circuitry 224 can include a respective PWM generator 234, 236 for each of the N phases, each having a respective input (or multiple inputs) and one of the respective pulse outputs 230, 232. Each of the PWM generators 234, 236 is configured to provide a pulsed signal, shown as PWM signals PWM1 through PWM_N, to control a respective power stage (e.g., power stage 102, 104, 106).

As shown in the example of FIG. 2, the multiphase loop controller 212 includes a current combiner (e.g., an adder or summation block) 240 having the phase current inputs 204 and 206 and an aggregate current output 242. The current combiner is configured to provide a combined measure of current based on measures of current for the phases of the power converter. For example, the current combiner is implemented as summation block configured add measured phase current values provided at each of the N phase current inputs 204 and 206. A gain circuit 244 has a gain input 246 and a gain output 248, in which the gain input is coupled to the aggregate current output 242. As an example, the gain circuit 244 is a multiplier configured to multiply the combined measure of current at 246 by a gain value provided at a gain input 247 to provide a respective product at the gain output 248. For example, the gain value at the gain input 247 is equal to or derived from a loadline impedance RLL for the multiphase power converter (e.g., the multiphase power converter circuit 100). In an analog implementation, the gain circuit can be implemented using amplifiers.

The multiphase loop controller 212 also includes a summation circuit 250 having a first summation input 252, a feedback input 254, and a summation output 256. The summation input 252 is coupled to the gain output 248 and the feedback input 254 is coupled to the feedback input 202. A second summation circuit 258 has a summation input 260, a reference voltage input 262, and a summation output 264. The summation input 260 is coupled to the first summation output 256 and the second summation output is coupled to the control loop output 214. The reference voltage input 262 can be coupled to an output of a DC voltage source (e.g., a DC voltage rail) that is configured to provide a reference voltage VREF. For example, the reference voltage VREF is a DC voltage having value that is less than an expected body diode voltage (e.g., VREF can range between 0 V and −0.5 V, such as −0.3 V). In some examples, a gain control circuit 266 has an input 268 coupled to the summation output 264 and an output 270 coupled to the control loop output 214 of the multiphase loop controller 212.

By way of example, the multiphase loop controller 212 is configured to provide a system error signal at the control loop output 214 based on a feedback signal VFB at the feedback input 202 and a combined measure of current at the phase current inputs 204 and 206. As described herein, the feedback signal can be representative of an output voltage of the multiphase power converter circuit (e.g., VOUT provided by the multiphase power converter circuit 100).

As a further example, the current combiner 240 is configured to provide a combined measure of current at 242 based on the measures of current for the respective phases of the multiphase power converter circuit. The combined measure of current is representative of aggregate current for the plurality of phases, shown as phase current signals IP1 through IPN. The gain circuit 244 is configured to multiply the combined measure of current at 246 by a gain value (e.g., loadline resistance RLL) to provide a respective product at the gain output 248. The summation circuit 250 is configured to provide a sum at summation output 256 that is representative of a sum of the respective product at 248 and the feedback signal VFB. The second summation circuit 258 is configured to provide a difference signal (e.g., a system error signal) at 264 based on a difference between the sum received at 260 and the reference voltage VREF. The gain control circuit 266 can implement proportional-integral-derivative (PID) control or other forms of control (e.g., proportional-derivative or proportional-integral control) configured to provide the system error signal based on performing respective mathematical control functions on the difference signal received at 268. The gain control circuit can be configured to implement other types of gain control function in other examples.

The per-phase loop controller 216 is configured to provide a respective phase error signal for each phase at the phase loop output 220 based on the feedback signal at the feedback input 222 and phase current signal at 218. As described herein, the per-phase loop controller 216 can include a phase loop controller for each phase of the multiphase power converter circuit, each of which being configured to provide a respective phase error signal. The pulse generator circuitry 224 is configured to provide phase control signals at 208 and 210 based on the loop control signal at 214 and the phase error signals at 220. For example, the pulse generator circuitry is configured to adjust the loop control signal provided at 214 based on the phase error signal for a respective phase. The per-phase adjustments can reduce systematic asymmetries that tend to occur across power stages of the multiphase power converter circuit (e.g., circuit 100), including to balance the loop responses of the respective phases. Also, or as an alternative, the per-phase adjustments can reduce effects resulting from differences in load line impedances that can exist for the different phases of the multiphase power converter circuit.

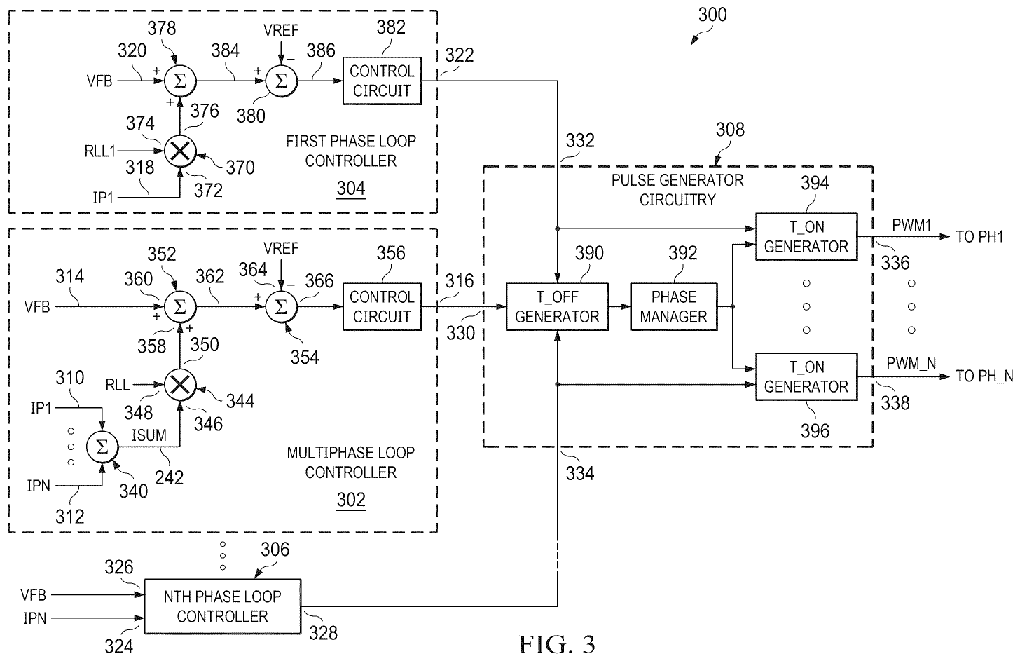

FIG. 3 is a block diagram illustrating another example controller 300 for a multiphase power converter circuit (e.g., the circuit 100). The controller 300 is an example of the controller 150 and 200 described with respect to FIGS. 1 and 2. Accordingly, the description of FIG. 3 may also refer to FIGS. 1 and 2. The controller 300 includes a multiphase loop controller 302, a plurality of N phase loop controllers (shown as first and Nth phase loop controllers 304 and 306), and pulse generator circuitry 308. Each of the N phase loop controllers 304 and 306 can be implemented as an instance of a respective control circuit that is configured to provide a phase error signal for a respective phase of the power converter circuit. The controller 300 can be implemented as an IC, by an arrangement of discrete components, or as a combination of one or more ICs and discrete components, which can include digital and/or analog components.

The multiphase loop controller 302 has phase current inputs 310 and 312, a feedback input 314, and a control loop output 316. The first phase loop controller 304 has a phase current input 318, a feedback input 320, and a phase loop output 322. The feedback input 320 is coupled to the feedback input 314 and the phase current input 318 is coupled to the phase current input 310 of the multiphase loop controller 302. The Nth phase loop controller 306 has a phase current input 324, a feedback input 326, and a phase loop output 328. The phase current input 324 is coupled to the phase current input 312 and the feedback input 326 is coupled to the feedback input 314.

The pulse generator circuitry 308 has a pulse control input 330 coupled to the control loop output 316 of the multiphase loop controller. The pulse generator circuitry 308 also includes pulse control inputs 332 and 334, which are coupled to phase loop outputs 322 and 328 of each of the respective phase loop controllers 304 and 306. The pulse generator circuitry 308 also includes pulse outputs 336 and 338, which also define respective outputs of the controller for providing control signals for controlling each of the respective power stages (e.g., power stages 102, 104, and 106).

In the example of FIG. 3, the multiphase loop controller 302 includes a current combiner (e.g., an adder or summation block) 340 having the phase current inputs 310 and 312 and an aggregate current output 342. A gain circuit 344 (e.g., a multiplier in a digital implementation or amplifiers in an analog implementation) has gain inputs 346 and 348 and a gain output 350. The gain input 346 is coupled to the aggregate current output 342 and the gain input 346 receives a gain value, which can be equal to or derived from a loadline impedance RLL for the multiphase power converter circuit (e.g., the circuit 100). The gain circuit 344 can be configured to multiply the combined measure of current at the gain input 346 by RLL provided at the gain input 348 and provide a respective product at the gain output 350.

The multiphase loop controller 302 also includes one or more summation circuits 352 and 354 and a control circuit 356. The summation circuit 352 has an input 358 coupled to the gain output 350 and another input 360 coupled to the feedback input 314. The summation circuit 352 is configured to provide an output at a summation output 362 based on a sum of the product at 358 and the feedback signal VFB at 360. The other summation circuit 354 has a summation input coupled to the summation output 362 and a summation input coupled to a reference voltage input 364. The reference voltage input 262 can be coupled to an output of voltage source (e.g., a voltage rail) that provides a DC reference voltage VREF. The summation circuit 354 is configured to provide a respective output value at a summation output 366 based on a difference between the signal at 362 and VREF. The control circuit 356 is coupled between the summation output 366 and the output 316. The control circuit 356 is configured to provide a system error signal at the output 316 based on a loop correction function. For example, the control circuit 356 is a PID controller that is configured to apply proportion, integral, and derivative control terms over time. The control circuit 356 can continuously modulate the system error signal at 316 based on the feedback signal VFB and aggregate measure of phase currents that vary over time. The control circuit 356 can implement other forms of control in other examples.

The phase loop controller 304 includes a gain circuit 370 (e.g., a multiplier) having gain inputs 372 and 374 and a gain output 376, in which the gain input 372 is coupled to the phase current input 318 to receive a measure of phase current (e.g., phase current signal IP1). The other gain input 374 receives a gain value, which is representative of a loadline impedance RLL1 for a first phase of power converter circuit (e.g., the circuit 100). The gain circuit 370 can be configured to multiply the measure of current IP1 and RLL1 to provide a respective product at the gain output 376.

In the example of FIG. 3, the phase loop controller 304 also includes one or more summation circuits 378 and 380 and a control circuit 382. The summation circuit 378 has an input coupled to the gain output 376 and another input coupled to the feedback input 320 to receive the feedback signal VFB. The summation circuit 378 is configured to provide an output at a summation output 384 having a value based on a sum of the product at 384 and the feedback signal VFB at 386. The other summation circuit 380 has a summation input coupled to the summation output 384 and another summation input coupled to a reference voltage input, which can receive a DC reference voltage VREF. The summation circuit 380 is configured to provide a respective output at a summation output 386 having a value based on a difference of the signal at 384 and VREF. The control circuit 382 is coupled between the summation output 386 and the output 322. The control circuit 382 is configured to provide a phase error signal at 322 based on a loop correction function that is applied over time. For example, the control circuit 382 is a proportional-derivative (PD) controller that includes proportion and derivative control terms applied over time. The phase error signal at 322 thus can be continuously modulated based on the feedback signal VFB and measured phase current signal IP1 that vary over time. The control circuit 382 can implement other forms of control in other examples.

Each of the other phase loop controllers, including the Nth phase loop controller 306 can be implemented as another instance of the phase loop controller 304. For example, each of the phase loop controllers includes a gain circuit, one or more summation circuits, and a proportional-derivative (PD) control circuit. Each phase loop controller 304, 306 thus is configured to provide a phase error signal at a phase loop output 322, 328 for a respective phase of the multiphase power converter circuit.

The pulse generator circuitry 308 is configured to combine the system error signal and the respective phase error signals and provide corresponding phase control signals at 336 and 338, shown as PWM1 and PWMN. In the example of FIG. 3, the pulse generator circuitry 308 includes an off-time (T_OFF) generator 390, a phase manager 392, and on-time (T_ON) generators 394 and 396. The off-time generator 390 includes inputs coupled to (or defining) the pulse control inputs 330, 332 and 334. The phase manager 392 has a phase control input and phase control outputs. The phase control input is coupled to the off-time output and the phase control outputs are coupled to inputs of the respective T_ON generators 394 and 396. Each of the T_ON generators has an output that is coupled to (or defines) the respective pulse outputs 336 and 338 (e.g., PWM output terminals of an IC containing the controller 300).

The T_OFF generator 390 is configured to provide an off-time signal (e.g., a signal timing pulse) based on the system error signal at 330 and one or more of the phase error signals at 332 and 334. The T_OFF generator 390 computes when to fire a pulse and the off-time signal indicates the computed timing for the pulse. In an example, the T_OFF generator 390 computes the pulse timing value as T_pulse=TSW/N(1−Verror/Vramp) and then generates the off-time signal using high frequency digital clock based on the pulse timing value T_pulse. The off-time signal defines the timing of a PWM signal for a next phase the T_pulse value. For example, the per-phase signal skews the timing between one phase and another.

The phase manager 392 is configured to perform phase management, which can include determining a sequence of active phases and balancing current between active phases of the power converter. In an example, the phase manager is implemented in digital logic (e.g., coded in a hardware description language, such as Verilog in digital domain) for distributing each pulse to a PWM generator in round robin fashion. This can further include adding or removing phases during transients. The phase manager 392 provides respective trigger signals to inputs of on-time generators 394 and 396, which triggers the T_ON generator of the next phase in the firing sequence to provide a PWM pulse with the right ON_time to the corresponding output 336 or 338.

In an example, the on-time duration (T_ON) can be approximated as T_ON=VOUT*TSW/VIN. The on-time generators 394 and 396 thus can be configured to calculate a value for T_ON, and a high frequency digital clock can generate the ON_time for the PWM signal based on the T_ON value. The on-time duration can also be modulated by the per-phase signals received at 332 and 334, which can vary the duty cycle from phase to phase. As an example, when a given phase needs higher gain than the other phases, the pulse generator circuitry would provide the PWM signal having an earlier than usual PWM rising edge (e.g., determined by the T_OFF generator) and that the PWM pulse would be wider (e.g., determined by the respective TON generator) than the other phases.

In view of the foregoing, the controller 300 is configured to provide per-phase error signals to adjust the common loop control signal. The controller also can implement loadline scaling as part of generating the per-phase error signal. The controller 300 can thus equalize load transient response in respective phases of a multiphase power converter that otherwise can be adversely affected by asymmetry among the respective phases.

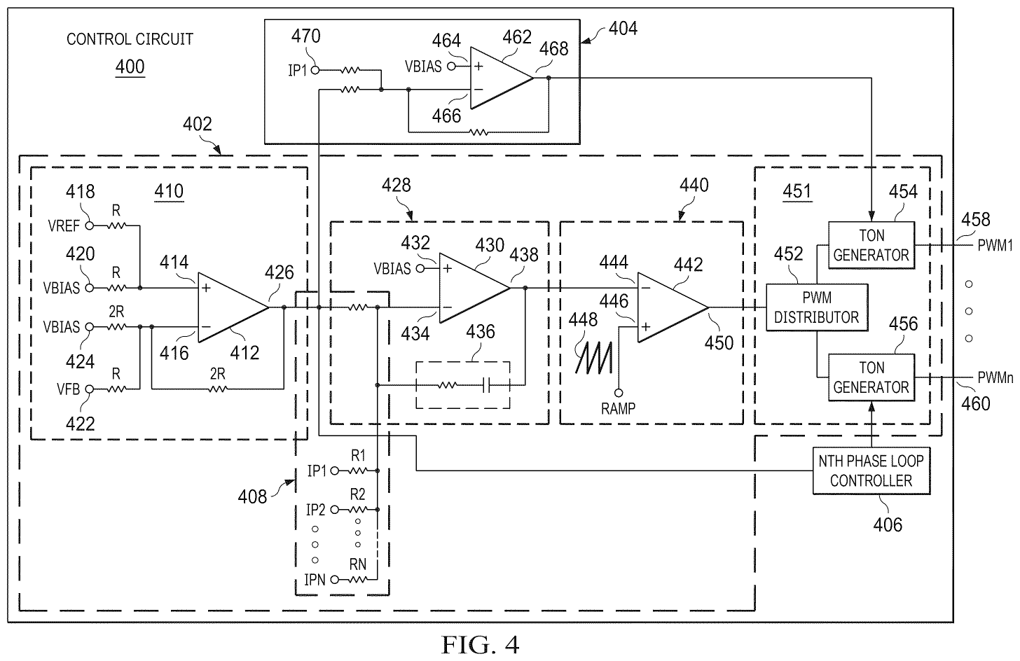

FIG. 4 is a schematic diagram illustrating an example analog control circuit 400 for a multiphase power converter circuit (e.g., the circuit 100). The control circuit is an example of an analog implementation that can be used to implement the controller 150, 200, 300. The description of FIG. 4 may refer to certain aspects of FIG. 1, 2, or 3. Other implementations can be used to implement a control circuit in other examples.

The control circuit 400 includes a multiphase control circuit 402 and per-phase loop control circuits 404 and 406 for each of a plurality of N phases. The multiphase control circuit 402 includes loadline circuitry 408 configured to apply a gain to the aggregate measure of current. For example, the loadline circuitry 408 includes an arrangement of resistors R1, R2 and RN, each coupled between a respective phase current input and an inverting input 434 of proportional and integral control circuitry 428. Each phase current input can be coupled to an output of a current sensor (e.g., current sensor 120, 122, 124) that is configured to provide a measure of current, shown as phase current signals IP1, IP2 through IPN, for each respective phase. The loadline circuitry 408 thus can perform loadline scaling functions analogous to current combiner 240 and gain circuit 244 of FIG. 2 or current combiner 340 and gain circuit 344 of FIG. 3.

Summation circuitry 410 includes an operational amplifier (op-amp) 412 having a non-inverting input 414 and an inverting input 416. The non-inverting input 414 is coupled to a reference input 418 through a first input resistor (e.g., having a resistance R) and a bias input 420 through another input resistor (e.g., also having a resistance R). The inverting input 416 is coupled to a feedback input 422 through a first input resistor (e.g., having a resistance R) and a bias input 424 through another input resistor (e.g., having a resistance 2R). A feedback resistor (e.g., having a resistance 2R) is coupled between the inverting input 416 and an output 426 of the op-amp 412. Each of the bias inputs 420 and 424 can receive a bias voltage VBIAS. The summation circuitry 410 is configured to provide an output signal based on a difference between the feedback voltage signal and a reference voltage (e.g., VREF-VFB). The subtraction circuit thus can perform functions analogous to the functions performed by summation circuits 250 and 258 of FIG. 2 or summation circuits 352 and 354 of FIG. 3.

The control circuit 400 also includes gain control circuitry 428. The gain control circuitry 428 can include an op-amp 430 having non-inverting and inverting inputs 432 and 434. The non-inverting input 432 receives a bias voltage (VBIAS). The inverting input 434 can be coupled to the output 426 of the op-amp through a resistor. A resistor-capacitor (RC) network 436 can be coupled between an output 438 of the op-amp 430 and the inverting input 434. The gain control circuitry 428 can be configured to implement proportional-derivative (PD) control or other forms of control (e.g., PID control, proportional-integral control, or the like) to provide a system error signal at the output 438.

The control circuit 400 can also include voltage-to-timing conversion circuitry 440. For example, an op-amp 442 has an inverting input 444, a non-inverting input 446 and an output 450. The inverting input is coupled to the output 438 of the op-amp 430. The non-inverting input is coupled to an output of a ramp generator (not shown), which is configured to provide a ramp signal 448. The op-amp is configured to provide a series of pulses (e.g., a PWM signal) at the output 450 based on a difference between the error signal at 444 and the ramp signal 448 at 446.

Pulse generator circuitry 451 includes a PWM distributor circuit 452 and T_ON generators 454 and 456 for the respective N phases. While the voltage-to-timing conversion circuitry 440 is shown as a separate block from the pulse generator circuitry 451 in FIG. 4, the voltage-to-timing conversion circuitry 440 can be considered as part of the pulse generator circuitry 451. The PWM distributor circuit 452 has an input coupled to the output 450 and outputs coupled to respective T_ON generators 454 and 456. Each of the T_ON generators 454, 456 has an output that is coupled to (or defines) respective pulse outputs 458, 460 of the control circuit 400.

The per-phase loop control circuit 404 includes an op-amp 462 having non-inverting and inverting inputs 464 and 466 and an output 468. The non-inverting input 464 receives a bias voltage VBIAS. The inverting input 466 can be coupled to the output 468 of the op-amp 462 through a resistor. The inverting input 466 can also be coupled to a phase current input 470 through another resistor. The phase current input 470 can be coupled to an output of a current sensor (e.g., current sensor 120) that is configured to provide a measure of current, shown as phase current signal IP1, for the respective phase. The inverting input 466 further can be coupled to the output 426 of the summation circuitry 410 through a resistor. Each of the other per-phase loop control circuits, including the Nth circuit 406, can be implemented as an instance of the same circuitry, such as shown for the per-phase loop control circuit 404.

The PWM distributor circuit 452 is configured to control the T_ON generators 454 and 456 to provide a PWM signal to a respective phase (e.g., to power stage 102, 104, 106). For example, the PWM distributor circuit 452 is configured to trigger a respective one of the T_ON generators 454, 456 to provide a respective PWM signal at the pulse output 458, 460 thereof responsive to the timing control signal provided at 450 (e.g., a pulsed signal provided by the timing conversion circuitry 440). The per-phase loop control circuits 404 and 406 can be configured to implement per-phase loadline and/or per-phase PD control and provide a phase error signal to an input of a respective T_ON generator 454, 456. For example, the T_ON generators 454 and 456 can be configured to adjust the on-time and/or pulse width of the respective PWM signal based on the phase error signal from the corresponding per-phase loop control circuits 404 and 406. As a result, performance of the multiphase power converter circuit can be improved by reducing asymmetry among the respective phases.

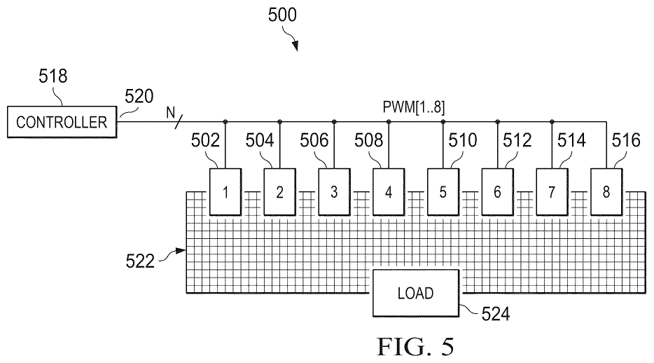

FIG. 5 is a block diagram of an example multiphase power converter circuit 500 having an arrangement of power stages (e.g., ICs) 502, 504, 506, 508, 510, 512, 514, and 516. The circuit includes a controller 518 having N (e.g., N=8) outputs 520 coupled to respective control input terminals of the power stages 502, 504, 506, 508, 510, 512, 514, and 516. Each of the power stages 502, 504, 506, 508, 510, 512, 514, and 516 has an output terminal coupled to a power supply plane (e.g., a bus, network, or mesh structure—also referred to as a VCC plane), shown at 522. One or more loads 524 can be coupled to the power supply plane to receive electrical power supplied by the multiphase power converter circuit 500.

In the example of FIG. 5, power stages 502 and 516 are further from the load than power stages 508 and 510, such that the parasitic resistance is the lower for power stages 508 and 510 and higher for power stages 502 and 516. Consequently, when there is a load transient and the controller 518 modulates the duty cycle of the PWM pulses, power stages 508 and 510 respond the most and their current increases more than the other power stages. Thus, the power stages closer to the load have higher effective loop gain and the power stages further from the load have lower effective loop gain. The controller 518 can be implemented by the example controllers 150, 200, 300, or 400 described herein to reduce (or eliminate) differences in the loop gain for the respective power stages that can result from different parasitic resistances.

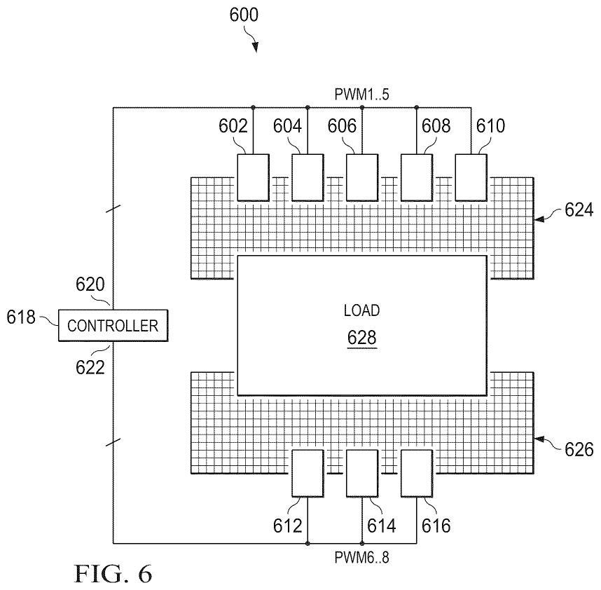

FIG. 6 is a block diagram of an example multiphase power converter circuit 600 having an arrangement of power stages (e.g., ICs) 602, 604, 606, 608, 610, 612, 614, and 616. The multiphase power converter circuit 600 includes a controller 618 having N (e.g., N=8) outputs, including first and second sets of outputs 620 and 622, coupled to respective control input terminals of the power stages 602, 604, 606, 608, 610, 612, 614, and 616. In the example of FIG. 6, each of the power stages 602, 604, 606, 608, and 610 has an output terminal coupled to a partitioned power supply plane 624 and a compensating inductor. Other numbers of stages Each of the power stages 612, 614, and 616 has an output terminal coupled to another power supply plane 626 and another compensating inductor. One or more loads 628 can be coupled to the power supply planes 624 and 626 to receive electrical power supplied by the multiphase power converter circuit 600. Gain from duty cycle to the total output current change in every switching cycle:

$$\frac{Δ I}{TSW} = N * ( \frac{Δ D}{D} ) * \frac{VOUT}{Lm} + ( {M}^{2} + {P}^{2} ) * ( \frac{Δ D}{D} ) * \frac{VOUT}{Lc} ,$$

where:
   ΔI represents a change in total output current;
   TSW represents switching frequency for the controller, which is the frequency at which each PWM is switching;
   ΔD represents a change in duty cycle for a transient condition;
   N represents the total number of stages (e.g., N=8);
   M represents the number of stages in one partition (e.g., M=5);
   P represents the number of stages in another partition (e.g., P=3);
   D represents steady state duty cycle for a particular VOUT and VIN;
   VOUT represents the output voltage controller is regulating;
   Lm represents magnetizing inductance value for TLVR Power delivery network; and
   Lc represents coupling inductor value for TLVR Power delivery network.
      However, the gain from duty cycle to per-phase output current change in every switching cycle can be different for the phases in the two partitions having N total power stages, such as:

For the partition with M power stages:

$$\frac{Δ I}{TSW} = ( \frac{Δ D}{D} ) * \frac{VOUT}{Lm} + M * ( \frac{Δ D}{D} ) * \frac{VOUT}{Lc}$$

and

For the partition with P power stages:

$$\frac{Δ I}{TSW} = ( \frac{Δ D}{D} ) * \frac{VOUT}{Lm} + P * ( \frac{Δ D}{D} ) * \frac{VOUT}{Lc} ,$$

where:
   ΔI represents a change in per phase output current;
   M represents the number of power stage in one patition;
      P represents the number of power stage in another patition, namely
   N=M+P (e.g., M=5, and P=3 in FIG. 6).

While the above example represents two partitions (one with 5 power stages and another with 3 power stages), the foregoing equations can be modified for different numbers of power stages as well as for a different number of partitions. Thus, in the absence of the controller 618 implementing per-phase control, as described herein, the gain for phases in the partition having five power stages would be higher than the partition having three (or another lower number of) power stages. That is, the per-phase loadline and gain scaling implemented by the controller 618 for each phase can reduce (or eliminate) mismatch caused by unequal numbers of power stages in different partitions.

By way of example, the gain from phase current to PWM duty cycle for a TLVR loop can be represented as follows:

$$\frac{Δ D}{D} = Iph * ( RLLph * GPDph + RLLloop * GPIDloop ) ,$$

where:
   ΔD represents a change in duty cycle for a transient condition;
   D represents the steady state duty cycle for a particular VOUT and VIN;
   Iph represents per phase current;
   RLLph represents per phase DC Loadline;
   GPDph reresents all theproportional and differential gain for per Phase path;
   RLLloop represents overall DC loadline for controller, which is multiplied by ISUM; and
   GPIDloop reresents all the Proportional, Integral and Differential Gain for overall controller (ISUM Path).

The gain from duty cycle to phase current for the TLVR loop can be represented as follows:

$$Iph = ( \frac{Δ D}{D} ) * TSW * VOUT * ( \frac{1}{Lm} + \frac{npart}{Lc} ) .$$

where:
   ΔD represents a change in duty cycle for a transient condition;
   D represetns the steady state duty cycle for a particular VOUT and VIN;
   Iph represents per phase current;
   TSW represents switching frequency for the controller, which is the frequency at which each PWM is switching;
VOUT represents the output voltage controller is regulating;
Lm represents magnetizing inductance value for TLVR Power delivery network; and
   Lc represents coupling inductor value for TLVR Power delivery network;
   npart represents the partition-dependent gain, based on the number of stages in each partition (e.g., M and P in the above equations).

The current loop gain (Gph) is the product of the above two expressions, which can be represented as follows:

$$Gph = ( RLLph * GPDph + RLLloop * GPIDloop ) * TSW * VOUT * ( \frac{1}{Lm} + \frac{npart}{Lc} ) .$$

where:
   RLLph represents per phase DC Loadline;
   GPDph reresents all theproportional and differential gain for per Phase path;
   RLLloop represents overall DC loadline for controller,
   GPIDloop reresents all the Proportional, Integral and Differential Gain for overall controller (ISUM Path);
   TSW represents switching frequency for the controller, which is the frequency at which each PWM is switching;
   VOUT represents the output voltage controller is regulating;
   Lm represents magnetizing inductance value for TLVR Power delivery network;
Lc represents coupling inductor value for TLVR Power delivery network; and
   npart represents the partition—dependent gain, based on the number of stages in each partition (e.g., M and P in the above equations).
      The gain mismatch created by unequal numbers of phases in respective partitions (nₚₐᵣₜ) is corrected by per-phase load line and PD gains, which can be implemented by per-phase loop control circuitry (e.g., per-phase loop controller 216, 304, 306 or per-phase loop control circuit 404, 406). Additionally, mismatches because of layout, such as the layout shown in FIG. 5, can also be corrected using per-phase load lines and/or gains, as described herein.

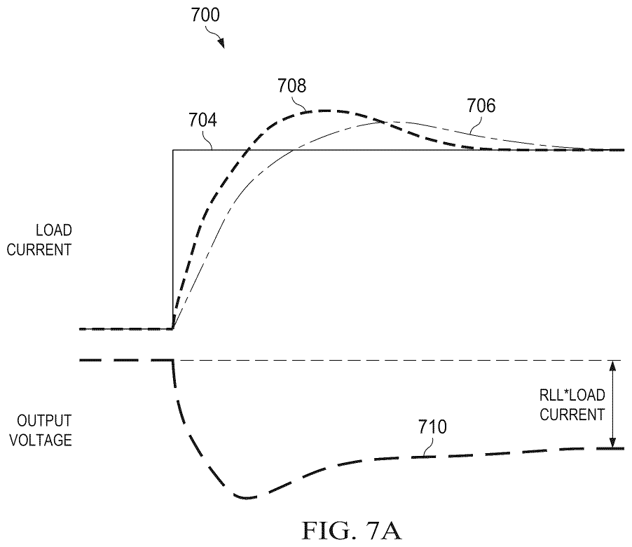

FIGS. 7A and 7B are plots 700 and 702 showing electrical parameters for different power converters. FIG. 7A shows a normalized (e.g., ideal) load current 704 and load currents 706 and 708 of phases having different gains during a load transient. The plot 700 also shows an output voltage 710, which is equal to the loadline resistance (RLL) times the load current. The load current 706 for phases having lower gains exhibits a more sluggish response to the load transient and the total current supplied by the power converter tracks the load current slower than if all the phases had equal gain. The load current 708 is for one or more phases having a higher gain than the load current 706. As shown in FIG. 7A, phase currents are unequal for some time after the load transient. Even though the difference between the phase currents can be corrected by an additional “current sharing loop” in steady state, the difference between the currents for some time risks the controller forcing the high-gain phases into “current limiting mode”, which would degrade the loop response. Also, higher currents occurring repeatedly on some phases but not others can also cause some power stages to age faster than others, thereby reducing the overall lifetime of the system. The controller described herein can reduce mismatch among the phases so the load current for each phase responds in a like manner during load transients, such as demonstrated by the phase current 712 and output voltage 714 in FIG. 7B.

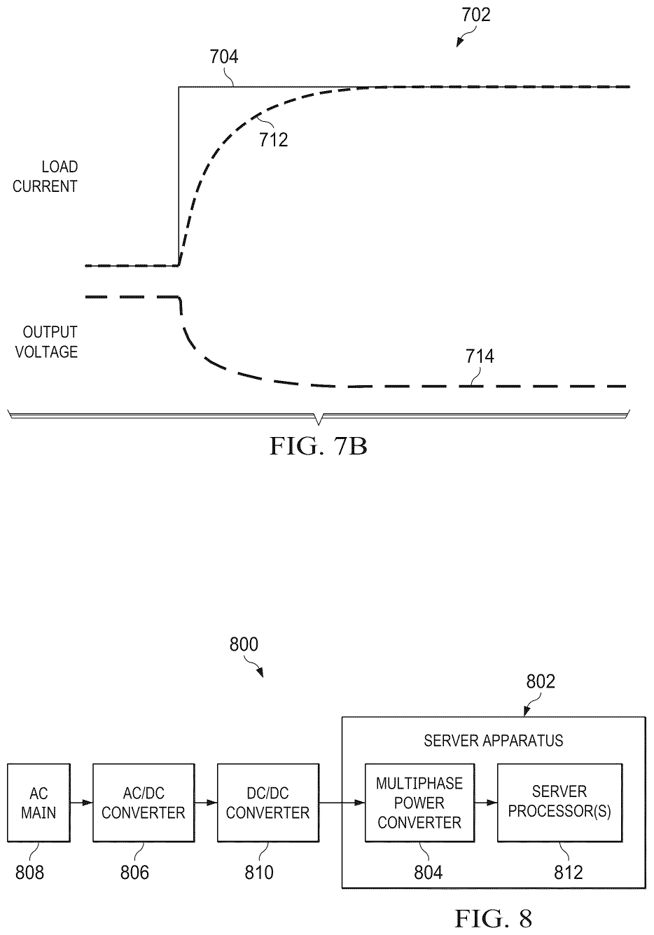

FIG. 8 is a block diagram illustrating a power system 800 for a computing system, which is shown as a server apparatus 802 implementing an example multiphase power converter 804. The multiphase power converter circuit 804 can be implemented according to any of the example embodiments described herein (see, e.g., FIGS. 1-6). The power system 800 includes an AC/DC converter 806 coupled to an input AC main power source 808. A DC/DC converter 810 has an input coupled to a DC output of the AC/DC converter 806. The multiphase power converter circuit 804 has an input coupled to the DC/DC converter 810 to receive DC power. The multiphase power converter circuit 804 includes a controller and a plurality of power stages. The controller of the multiphase power converter circuit 804 includes per-phase loop control circuitry configured to implement per-phase loadline and/or gain scaling for at least some of the phases, as described herein, to reduce gain mismatch and/or asymmetry between the phases. Other types and configurations of power systems can use the multiphase power converter circuit 804 to supply power to various other types of loads based on this description.

In this description, the term “couple” or “couples” means either an indirect or direct connection. Thus, if a first device couples to a second device, that connection may be through a direct connection or through an indirect connection via other devices and connections. For example, if device A generates a signal to control device B to perform an action, then: (a) in a first example, device A is coupled to device B; or (b) in a second example, device A is coupled to device B through intervening component C if intervening component C does not alter the functional relationship between device A and device B, so device B is controlled by device A via the control signal generated by device A.

Also, in this description, a device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof. Furthermore, a circuit or device described herein as including certain components may instead be configured to couple to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor wafer and/or integrated circuit (IC) package) and may be configured to couple to at least some of the passive elements and/or the sources to form the described structure, either at a time of manufacture or after a time of manufacture, such as by an end user and/or a third party.

The recitation “based on” means “based at least in part on.” Therefore, if X is based on Y, X may be a function of Y and any number of other factors.

Modifications are possible in the described embodiments, and other embodiments are possible, within the scope of the claims.

What is claimed is:

1. A circuit comprising:
a multiphase loop controller having phase current inputs, a feedback input, and a control loop output;
a first phase loop controller having a first phase current input, a first feedback input, and a first phase loop output, in which the first feedback input is coupled to the feedback input of the multiphase loop controller;
a second phase loop controller having a second phase current input, a second feedback input, and a second phase loop output; and
pulse generator circuitry having first, second, and third pulse control inputs, and first and second pulse outputs, in which the first pulse control input is coupled to the control loop output of the multiphase loop controller, the second pulse control input is coupled to the first phase loop output of the first phase loop controller, and the third pulse control input is coupled to the second phase loop output of the second phase loop controller.

2. The circuit of claim 1, wherein the multiphase loop controller comprises:
a current combiner having the phase current inputs and an aggregate current output;
a gain circuit having a gain input and a gain output, in which the gain input is coupled to the aggregate current output;
a first summation circuit having the feedback input, a first summation input, and a first summation output, in which the first summation input is coupled to the gain output; and
a second summation circuit having a second summation input, a reference voltage input, and a second summation output, in which the second summation input is coupled to the first summation output and the second summation output is coupled to the control loop output.

3. The circuit of claim 2, wherein the gain circuit is a first gain circuit, the reference voltage input is a first reference voltage input, and the first phase loop controller comprises:
a second gain circuit having the first phase current input and a second gain output;
a third summation circuit having the first feedback input, a third summation input, and a third summation output, in which the third summation input is coupled to the second gain output; and
a fourth summation circuit having a fourth summation input, a second reference voltage input, and a fourth summation output, in which the fourth summation input is coupled to the third summation output and the fourth summation output is coupled to the first phase loop output.

4. The circuit of claim 3, wherein the second phase loop controller comprises:
a third gain circuit having the second phase current input and a third gain output;
a fifth summation circuit having the second feedback input, a fifth summation input, and a fifth summation output, in which the fifth summation input is coupled to the third gain output; and
a sixth summation circuit having a sixth summation input, a third reference voltage input, and a sixth summation output, in which the sixth summation input is coupled to the fifth summation output and the sixth summation output is coupled to the second phase loop output.

5. The circuit of claim 1, wherein the pulse generator circuitry comprises:
a first pulse width modulation (PWM) generator having a first PWM input and a first PWM output, in which the first PWM output is coupled to first pulse output; and
a second PWM generator having a second PWM input and a second PWM output, in which the second PWM output is coupled to second pulse output.

6. The circuit of claim 1, wherein the pulse generator circuitry comprises:
an off-time generator having first, second, and third time inputs and an off-time output, in which the first time input is coupled to the first pulse control input, the second time input is coupled to the second pulse control input, and the third time input is coupled to the third pulse control input,
a phase manager having a phase control input and a phase control output, in which the phase control input is coupled to the off-time output;
a first on-time generator having fourth and fifth time inputs and the first pulse output, in which the fourth time input is coupled to the phase control output, and the fifth time input is coupled to the first phase loop output; and
a second on-time generator having sixth and seventh time inputs and the second pulse output, in which the sixth time input is coupled to the phase control output, and the seventh time input is coupled to the second phase loop output.

7. The circuit of claim 6, wherein:
the multiphase loop controller is configured to provide a system error signal at the control loop output based on a feedback signal at the feedback input and a combined measure of current at the phase current inputs, in which the feedback signal is representative of an output voltage of a power converter, and the combined measure of current is representative of current of a plurality of phases of the power converter,
the first phase loop controller is configured to provide a first phase error signal at the first phase loop output based on the feedback signal at the first feedback input and a first current signal at the first phase current input, in which the first current signal is representative of a measure of current of a first phase of the power converter,
the second phase loop controller is configured to provide a second phase error signal at the second phase loop output based on the feedback signal at the second feedback input and a second current signal at the second phase current input, in which the second current signal is representative of a measure of current of a second phase of the power converter.

8. The circuit of claim 7, wherein:
the off-time generator is configured to provide an off-time signal at the off-time output based on the system error signal, the first phase error signal, and the second phase error signal,
the phase manager is configured to provide a phase control signal at the phase control output based on the off-time signal,
the first on-time generator is configured to provide a first PWM signal at the first pulse output based on the phase control signal and the first phase error signal, and
the second on-time generator is configured to provide a second PWM signal at the second pulse output based on the phase control signal and the second phase error signal.

9. The circuit of claim 5, further comprising:
a first power stage having a first control input and a first switching output, in which the first control input is coupled to the first PWM output and the first switching output is coupled to an output terminal of a power converter, and the feedback input is a coupled to the output terminal; and
a second power stage having a second control input and a second switching output, in which the second control input is coupled to the second PWM output and the second switching output is coupled to the output terminal of the power converter.

10. The circuit of claim 9, further comprising:
a first transformer having respective primary and secondary windings, in which the primary winding of the first transformer is coupled between the first switching output and the output terminal of the power converter; and
a second transformer having respective primary and secondary windings, in which the primary winding of the second transformer is coupled between the second switching output and the output terminal of the power converter,
wherein the secondary windings of the first and second transformers are coupled in series with a compensation inductor.

11. The circuit of claim 10, further comprising:
a first current sensor having a first current sense output coupled to the first phase current input, in which the first current sensor is configured to provide a first current signal at the first current sense output, and the first current signal is representative of a measure of current through the primary winding of the first transformer; and
a second current sensor having a second current sense output coupled the second phase current input, in which the second current sensor is configured to provide a second current signal at the second current sense output, and the second current signal is representative of a measure of current through the primary winding of the second transformer.

12. A circuit, comprising:
a multiphase loop controller configured to provide a system error signal based on a feedback signal and a combined measure of current, in which the feedback signal is representative of a power converter output voltage, and the combined measure of current is representative of current provided to a plurality of power converter phases;
a per-phase loop controller configured to provide a phase error signal for a respective phase of the plurality of power converter phases based on the feedback signal and a measure of current of the respective phase; and
pulse generator circuitry configured to provide a pulsed signal for the respective phase responsive to the phase error signal and the system error signal.

13. The circuit of claim 12, wherein the per-phase loop controller is a first per-phase loop controller, the phase error signal is a first phase error signal, the pulsed signal is a first pulsed signal, the respective phase is a first phase of the plurality of power converter phases, the measure of current of the respective phase is a first measure of current, and the circuit further comprises:
a second per-phase loop controller configured to provide a second phase error signal for a second phase of the plurality of phases based on the feedback signal and a second measure of current of the second phase, wherein the pulse generator circuitry comprises:
an off-time generator configured to provide an off-time signal based on the system error signal, the first phase error signal, and the second phase error signal;
a phase manager configured to provide a first and second phase control signals based on the off-time signal;
a first PWM generator configured to provide a first PWM signal based on the first phase control signal and the first phase error signal; and
a second PWM generator configured to provide a second PWM signal based on the second phase control signal and the second phase error signal.

14. The circuit of claim 13, further comprising:
a first power stage configured to provide a first phase voltage at a first switching output based on the first PWM signal; and
a second power stage configured to provide a second phase voltage at a second switching output based on the second PWM signal.

15. The circuit of claim 14, further comprising:
a first transformer having respective primary and secondary windings, in which the primary winding of the first transformer is coupled between the first switching output and an output terminal of a power converter; and
a second transformer having respective primary and secondary windings, in which the primary winding of the second transformer is coupled between the second switching output and the output terminal of the power converter,
a first current sensor configured to provide the first measure of current based on current through the primary winding of the first transformer; and
a second current sensor configured to provide the second measure of current based on current through the primary winding of the second transformer.

16. The circuit of claim 15, wherein the multiphase loop controller comprises:
a current combiner configured to provide the combined measure of current based on measures of current for the phases of the power converter;
a gain circuit configured to multiply the combined measure of current by a gain value to provide a respective product;
a first summation circuit configured to provide a first sum representative of a sum of the respective product and the feedback signal; and
a second summation circuit configured to provide a difference signal based on a difference between the first sum and a reference voltage, the system error signal being provided based on the difference signal.

17. The circuit of claim 16, wherein the gain circuit is a first gain circuit, the gain value is a first gain value, the difference signal is a first difference signal, and the per-phase loop controller comprises:
a second gain circuit configured to multiply the measure of current of the respective phase by a second gain value to provide a second product;
a third summation circuit configured to provide a third sum representative of a sum of the second product and the feedback signal; and
a fourth summation circuit configured to provide a second difference signal for the respective phase based on a difference between the third sum and a respective reference voltage, the phase error signal for the respective phase based on the second difference signal.

18. A power converter circuit comprising:
a control circuit comprising:
a multiphase loop controller having first and second phase current inputs, a first feedback input, and a control loop output, in which the first feedback input is coupled to an output terminal of the power converter circuit;
a first phase loop controller having a first phase current input, a second feedback input, and a first phase loop output, in which the second feedback input is coupled to the first feedback input;
a second phase loop controller having a second phase current input, a third feedback input, and a second phase loop output;
a pulse generator circuit having first, second, and third pulse control inputs and first and second pulse outputs, in which the first pulse control input is coupled to the control loop output, the second pulse control input is coupled to the first phase loop output, and the third pulse control input is coupled to the second phase loop output; and
a first power stage having a first control input and a first switching output, in which the first control input is coupled to the first pulse output, the first switching output is coupled to the output terminal; and
a second power stage having a second control input and a second switching output, in which the second control input is coupled to the second pulse output and the second switching output is coupled to the output terminal.

19. The power converter circuit of claim 18, further comprising:
a first transformer having respective primary and secondary windings, in which the primary winding of the first transformer is coupled between the first switching output and the output terminal;
a second transformer having respective primary and secondary windings, in which the primary winding of the second transformer is coupled between the second switching output and the output terminal; and
a compensation inductor coupled in series with the secondary winding of the first transformer and the secondary winding of the second transformer.

20. The power converter circuit of claim 18,
wherein the first phase loop controller comprises:
a first gain circuit having the first phase current input and a first gain output;
a first summation circuit having the second feedback input, a first summation input, and a first summation output, in which the first summation input is coupled to the first gain output; and
a second summation circuit having a second summation input, a first reference voltage input, and a second summation output, in which the second summation input is coupled to the first summation output and the second summation output is coupled to the first phase loop output, and
wherein the second phase loop controller comprises:
a second gain circuit having the second phase current input and a second gain output;
a third summation circuit having the third feedback input, a third summation input, and a third summation output, in which the second summation input is coupled to the second gain output; and
a fourth summation circuit having a fourth summation input, a third reference voltage input, and a fourth summation output, in which the fourth summation input is coupled to the third summation output and the fourth summation output is coupled to the second phase loop output.
